(19) United States
(12) Patent Application Publication
(10) Pub. No.: US 2015/0100213 A1
(43) Pub. Date: Apr. 9, 2015

(54) VEHICLE ALERTING DEVICE

(71) Applicant: Ming-Liang Hu, Tainan City (TW)

(72) Inventor: Ming-Liang Hu, Tainan City (TW)

(21) Appl. No.: 14/046,542

(22) Filed: Oct. 4, 2013

(51) Int. Cl. B60Q 1/30

(52) U.S. Cl. CPC B60Q 1/30
USPC 701/70

(57) ABSTRACT

A vehicle alerting device is to be mounted to a rear side portion of a vehicle and includes first and second groups of light emitting components mounted to a base seat, and a central control unit receiving a brake lamp signal and turn signals from the vehicle, and controlling activation and deactivation of the light emitting components. The central control unit drives the first group of the light emitting components to emit light when receiving the left turn lamp signal, drives the second group of the light emitting components to emit light when receiving the right turn lamp signal, and drives at least a portion of the first and second groups of the light emitting components to emit light when receiving the brake lamp signal.

### BACKGROUND OF THE INVENTION

1. Field of the Invention

The invention relates to an alerting device, and more particularly to a vehicle alerting device.

2. Description of the Related Art

When a vehicle is driven during daytime, turn lamps and brake lamps at a rear side portion of the vehicle are used to alert other vehicles regarding the driver's operation or intention. During night time, additional tail lamps will be turned on when the headlamps are turned on to attract the attention of other drivers.

In general, the brake lamps are mounted to the rear side portion of the vehicle, and the turn lamps may be mounted to each of a front portion, a lateral portion and the rear portion of the vehicle. However, promoting safety when driving is always a goal in the industry.

### SUMMARY OF THE INVENTION

Therefore, an object of the present invention is to provide a vehicle alerting device that may provide auxiliary alert to other vehicles.

According to the present invention, a vehicle alerting device is adapted to be mounted to a rear side portion of a vehicle. The vehicle includes a vehicle lamp control unit that provides a brake lamp signal when the vehicle is braked, a left turn lamp signal when a left turn lamp of the vehicle is turned on, and a right turn lamp signal when a right turn lamp of the vehicle is turned on. The vehicle alerting device comprises:

a light emitting unit including a base seat, and a plurality of light emitting components that are mounted on the base seat; and

a central control unit to be coupled to the vehicle lamp control unit for receiving the brake lamp signal, the left turn lamp signal, and the right turn lamp signal therefrom, and coupled to the light emitting unit to control activation and deactivation of the light emitting components.

The light emitting unit includes first and second groups of the light emitting components.

The central control unit drives the first group of the light emitting components to emit light when the left turn lamp signal is received thereby, drives the second group of the light emitting components to emit light when the right turn lamp signal is received thereby, and drives at least a portion of the first group and the second group of the light emitting components to emit light when the brake lamp signal is received thereby.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram showing a preferred embodiment of a vehicle alerting device according to the present invention that is mounted to a rear side portion of a vehicle;

FIG. 2 is a schematic diagram showing a front view of the preferred embodiment;

FIG. 3 is a block diagram of the preferred embodiment;

FIG. 4 is a schematic diagram illustrating a first operation state of the preferred embodiment;

FIG. 5 is a schematic diagram illustrating a second operation state of the preferred embodiment;

FIG. 6 is a schematic diagram illustrating a third operation state of the preferred embodiment;

FIG. 7 is a schematic diagram illustrating a fourth operation state of the preferred embodiment;

FIG. 8 is a schematic diagram illustrating a fifth operation state of the preferred embodiment; and

FIG. 9 is a schematic diagram illustrating a sixth operation state of the preferred embodiment.

### DETAILED DESCRIPTION OF THE PREFERRED EMBODIMENT

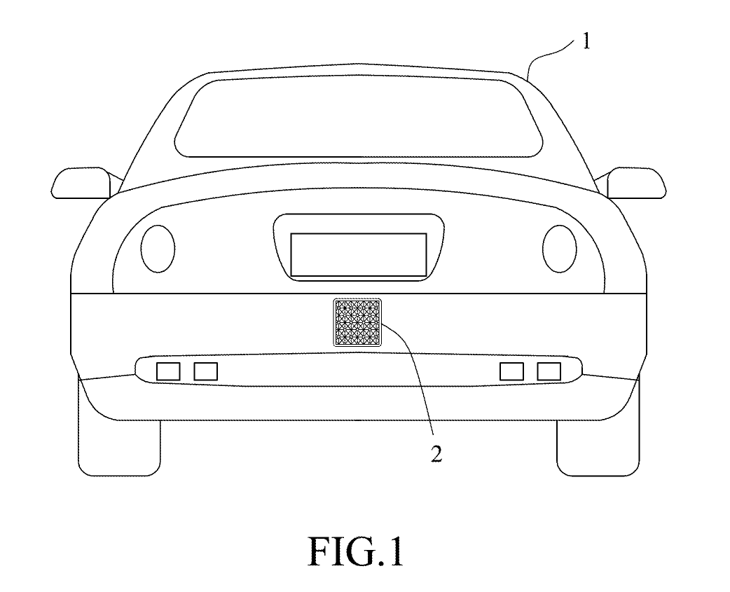

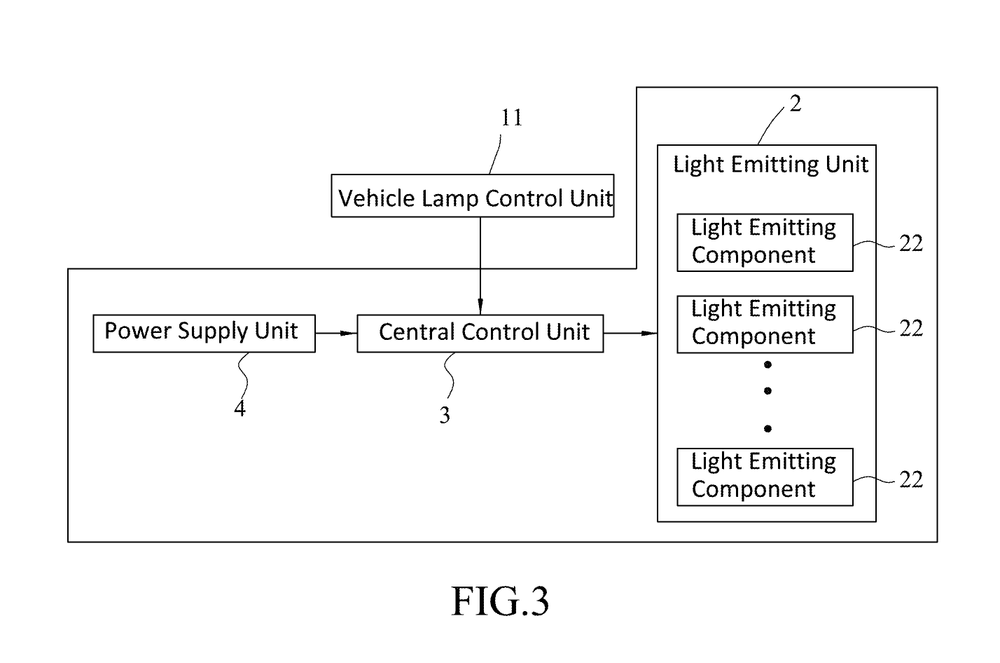

Referring to FIGS. 1 to 3, the preferred embodiment of the vehicle alerting device according to this invention is shown to be mounted at a rear side portion of a vehicle 1. The vehicle 1 includes a vehicle lamp control unit 11 that provides a brake lamp signal when the vehicle 1 is braked, a left turn lamp signal when a left turn lamp of the vehicle 1 is turned on, a right turn lamp signal when a right turn lamp of the vehicle 1 is turned on, and a headlamp signal when a headlamp of the vehicle 1 is turned on. In this embodiment, the vehicle 1 is a car, and may be a truck, an electric vehicle, or any other kind of motor vehicle in other embodiments. The vehicle lamp control unit 11 may include a brake pedal that controls a brake of the vehicle 1, and a lamp control mechanism that activates and deactivates turn lamps and headlamps of the vehicle 1. The vehicle alerting device of this invention includes a light emitting unit 2, a central control unit 3 coupled to the light emitting unit 2, and a power supply unit 4 coupled to the central control unit 3 for supplying working power thereto. The power supply unit 4 may include a DC power converter (not shown) coupled to a battery (not shown) of the vehicle 1.

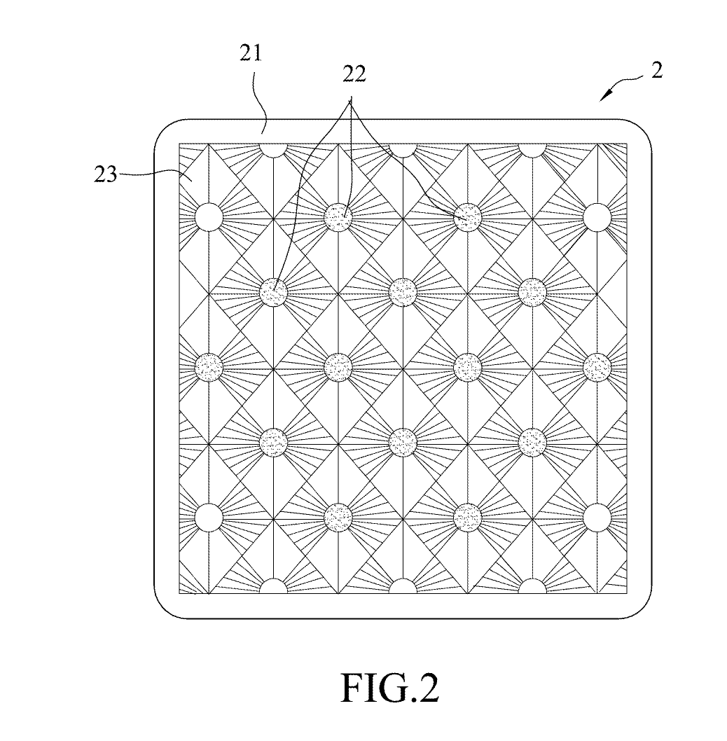

The light emitting unit 2 includes a base seat 21, a plurality of light emitting components 22 (e.g., light emitting diodes) that are mounted on the base seat 21, and a lamp cover 23. In this embodiment, the base seat 21 is mounted to a central position of the rear side portion of the vehicle 1. The light emitting components 22 are separately disposed on the base seat 21, and the lamp cover 23 is light-transmissive and is disposed to cover the base seat 21. In this embodiment, the lamp cover 23 is designed to have a light-guiding pattern (see FIG. 2). Since the light-guiding pattern is not a characterizing feature of this invention, further details of the light-guiding pattern will be omitted herein for the sake of brevity. For illustrating different intensities of light emitted from the light emitting components 22 in the drawings, higher intensity is shown by black dots with higher density, and lower intensity is shown by black dots with lower density. It should be noted that the densities of the black dots drawn in each of the drawings do not specify certain light intensities, but are only used for distinguishing among different light intensities in a specified operation state. In this embodiment, the light emitting components 22 are disposed only on the locations of the circles having the black dots in FIG. 2. In other embodiments, the locations of the light emitting components 22 are not limited thereto. For example, the light emitting components 22 may be disposed on all of locations of the circles shown in FIG. 2.

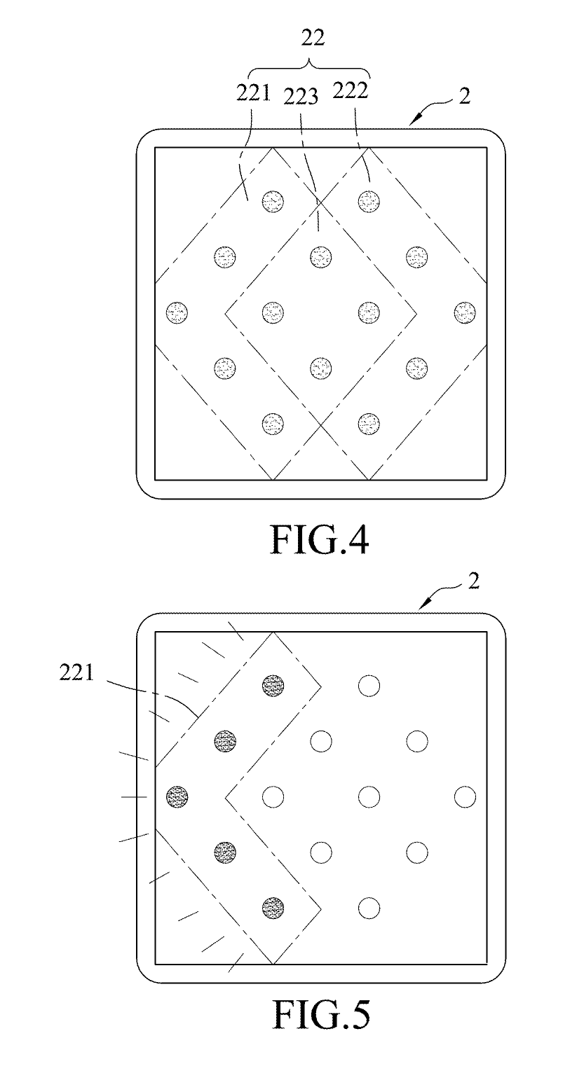

In this embodiment, with reference to FIG. 4, the light emitting unit 2 includes a first group 221, a second group 222 and a third group 223 of the light emitting components 22. The first group 221 of the light emitting components 22 is mounted on the base seat 21 so as to form a left turn pattern when driven to emit light, and the second group 222 of the light emitting components 22 is mounted on the base seat 21 so as to form a right turn pattern when driven to emit light. The third group 223 of the light emitting components 22 is mounted on the base seat 21 and is surrounded by the first group 221 and the second group 222 of the light emitting components 22.

The central control unit 3 is coupled to the vehicle lamp control unit 11 for receiving the brake lamp signal, the left turn lamp signal, and the right turn lamp signal therefrom, optionally receives the headlamp signal therefrom, and is coupled to the light emitting unit 2 for control activation and deactivation of the light emitting components 22. The central control unit 3 may include a microcontroller unit (MCU), and stores program instructions which, when executed by the MCU, enables the MCU to control activation and deactivation of the light emitting components 22 according to the lamp signals received from the vehicle lamp control unit 11.

Hereinafter, FIGS. 4 to 8 are used to illustrate operation states of the vehicle alerting device when the central control unit 3 does not receive the headlamp signal from the vehicle lamp control unit 11. Referring to FIGS. 4, 7 and 8, the central control unit 3 drives the third group 223 of the light emitting components 22 to emit light with a first intensity when the brake lamp signal is received thereby. It should be noted that, when the central control unit 3 receives only the brake lamp signal, at least a portion of the first group 221 and the second group 222 of the light emitting components 22 is also controlled by the central control unit 3 to emit light with the first intensity. In this embodiment, all of the first, second and third groups 221, 222, 223 of the light emitting components 22 are controlled by the central control unit 3 to emit light with the first intensity when the central control unit 3 receives only the brake lamp signal.

Referring to FIG. 5 (the central control unit 3 receives only the left turn lamp signal) and FIG. 7 (the central control unit 3 receives both the left turn lamp signal and the brake lamp signal), the central control unit 3 drives the first group 221 of the light emitting components 22 to emit light with a second intensity higher than the first intensity when the left turn lamp signal is received thereby and regardless of whether the brake lamp signal is received by the central control unit 3. In one embodiment, the central control unit 3 controls the first group 221 of the light emitting components 22 to emit light with the second intensity in a blinking manner in such a condition.

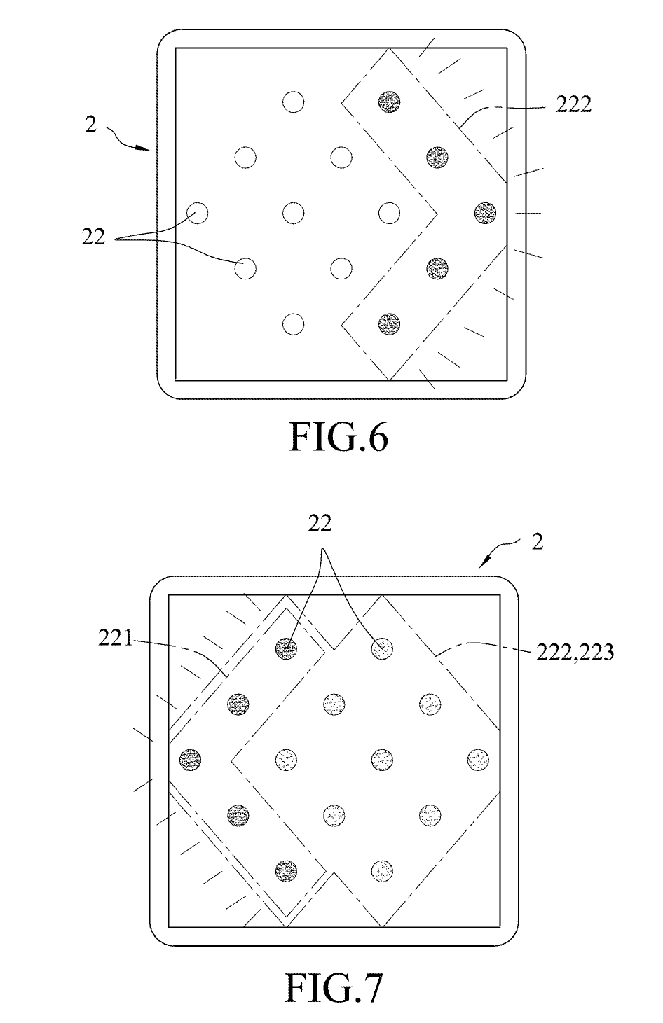

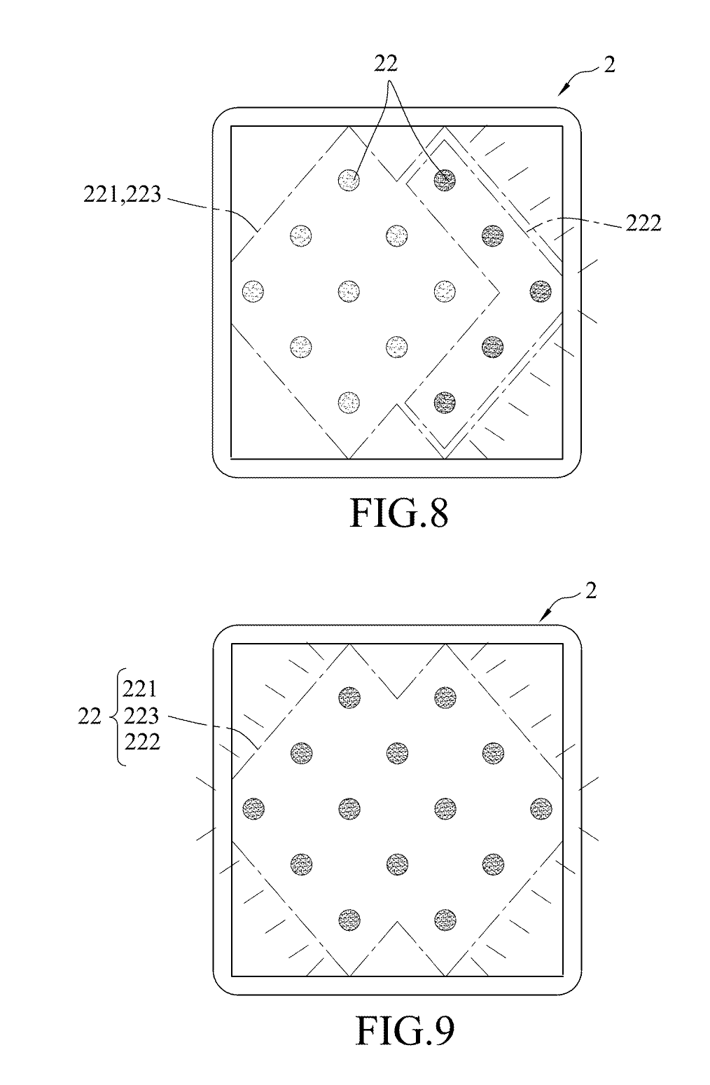

Referring to FIG. 6 (the central control unit 3 receives only the right turn lamp signal) and FIG. 8 (the central control unit 3 receives both the right turn lamp signal and the brake lamp signal), the central control unit 3 drives the second group 222 of the light emitting components 22 to emit light with a third intensity higher than the first intensity when the right turn lamp signal is received thereby and regardless of whether the brake lamp signal is received by the central control unit 3. In one embodiment, the central control unit 3 controls the second group 222 of the light emitting components 22 to emit light with the third intensity in a blinking manner in such a condition.

When ambient light is not sufficient, the driver of the vehicle 1 may turn on the headlamps of the vehicle 1. Hereinafter, FIGS. 4 and 7 to 9 are used to illustrate operation states of the vehicle alerting device when the headlamps of the vehicle 1 are turned on (that is, the central control unit 3 receives the headlamp signal), and operations of the vehicle alerting device in such a condition are described as follows. In this embodiment, when the central control unit 3 only receives the headlamp signal, the vehicle alerting device shows the same pattern as that shown in FIG. 4, while the present invention should not be limited thereto. The central control unit 3 drives the first group 221 of the light emitting components 22 to emit light with a fourth intensity lower than the first intensity when both of the brake lamp signal and the left turn lamp signal are not received by the central control unit 3 (as shown in FIGS. 4 and 8), drives the second group 222 of the light emitting components 22 to emit light with the fourth intensity when both of the brake lamp signal and the right turn lamp signal are not received by the central control unit 3 (as shown in FIGS. 4 and 7), and drives the third group 223 of the light emitting components 22 to emit light with the fourth intensity when the brake lamp signal is not received by the central control unit (as shown in FIGS. 4, 7 and 8).

In general, indications of the turn lamps have higher importance than that of the brake lamps, and the indications of the brake lamps have higher importance than that of the headlamps. Therefore, the central control unit 3 is configured to drive the third group 223 of the light emitting components 22 to emit light with a fifth intensity higher than the fourth intensity when the brake lamp signal is also received thereby (as shown in FIG. 9).

Similarly, the central control unit 3 is configured to drive the first group 221 of the light emitting components 22 to emit light with the fifth intensity when the brake lamp signal is also received thereby (as shown in FIG. 9), and is further configured to emit light with a sixth intensity higher than the fifth intensity when the left turn lamp signal is also received thereby and regardless of whether the brake lamp signal is also received by the central control unit 3 (as shown in FIG. 7).

Also, the central control unit 3 is configured to drive the second group 222 of the light emitting components 22 to emit light with the fifth intensity when the brake lamp signal is also received thereby (as shown in FIG. 9), and to emit light with a seventh intensity higher than the fifth intensity when the right turn lamp signal is also received thereby and regardless of whether the brake lamp signal is also received by the central control unit 3 (as shown in FIG. 8).

It should be noted that, in this embodiment, the fifth intensity is equal to the first intensity, the sixth intensity is equal to the second intensity, and the seventh intensity is equal to the third intensity. In other embodiments, the fifth, sixth and seventh intensity may differ from the first, second and third intensities, respectively. In addition, the central control unit 3 deactivates the first group 221 of the light emitting components 22 when all of the brake lamp signal, the right turn lamp signal and the headlamp signal are not received thereby, deactivates the second group 222 of the light emitting components 22 when all of the brake lamp signal, the left turn lamp signal and the headlamp signal are not received thereby, and deactivates the third group 223 of the light emitting components 22 when both of the brake lamp signal and the headlamp signal are not received thereby.

It should be noted that the intensity of light emitted by the light emitting components 22 may be controlled by the central control unit 3 using direct current magnitude control, pulse width modulation (PWM), or any other conventional method for driving the light emitting components 22.

To sum up, the vehicle alerting device according to the present invention may display different patterns with different intensities according to the operation (e.g., brake, turn on the turn lamps or headlamps) of the vehicle driver, so as to provide additional alert to other vehicles, thereby reducing occurrence of traffic accidents.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A vehicle alerting device adapted to be mounted to a rear side portion of a vehicle, the vehicle including a vehicle lamp control unit that provides a brake lamp signal when the vehicle is braked, a left turn lamp signal when a left turn lamp of the vehicle is turned on, and a right turn lamp signal when a right turn lamp of the vehicle is turned on, said vehicle alerting device comprising:
a light emitting unit including a base seat, and a plurality of light emitting components that are mounted on said base seat; and
a central control unit to be coupled to the vehicle lamp control unit for receiving the brake lamp signal, the left turn lamp signal, and the right turn lamp signal therefrom, and coupled to said light emitting unit to control activation and deactivation of said light emitting components;
wherein said light emitting unit includes first and second groups of said light emitting components,
said central control unit driving said first group of said light emitting components to emit light when the left turn lamp signal is received thereby, driving said second group of said light emitting components to emit light when the right turn lamp signal is received thereby, and driving at least a portion of said first group and said second group of said light emitting components to emit light when the brake lamp signal is received thereby.

2. The vehicle alerting device as claimed in claim 1, wherein said central control unit is configured to
drive said first group of said light emitting components to emit light with a first intensity when the brake lamp signal is received thereby, and to emit light with a second intensity higher than the first intensity when the left turn lamp signal is received thereby and regardless of whether the brake lamp signal is received by said central control unit, and
drive said second group of said light emitting components to emit light with the first intensity when the brake lamp signal is received thereby, and to emit light with a third intensity higher than the first intensity when the right turn lamp signal is received thereby and regardless of whether the brake lamp signal is received by said central control unit.

3. The vehicle alerting device as claimed in claim 1, the vehicle lamp control unit further providing a headlamp signal when a headlamp of the vehicle is turned on, wherein said central control unit further receives the headlamp signal, and is configured to, when the headlamp signal is not received thereby,
drive said first group of said light emitting components to emit light with a first intensity when the brake lamp signal is received thereby, and to emit light with a second intensity higher than the first intensity when the left turn lamp signal is received thereby and regardless of whether the brake lamp signal is received by said central control unit, and
drive said second group of said light emitting components to emit light with the first intensity when the brake lamp signal is received thereby, and to emit light with a third intensity higher than the first intensity when the right turn lamp signal is received thereby and regardless of whether the brake lamp signal is received by said central control unit; and
wherein said central control unit is further configured to, when the headlamp signal is received thereby,
drive said first group of said light emitting components to emit light with a fourth intensity lower than the first intensity when both of the brake lamp signal and the left turn lamp signal are not received by said central control unit, to emit light with a fifth intensity higher than the fourth intensity when the brake lamp signal is received thereby, and to emit light with a sixth intensity higher than the fifth intensity when the left turn lamp signal is received thereby and regardless of whether the brake lamp signal is received by said central control unit, and
drive said second group of said light emitting components to emit light with the fourth intensity when both of the brake lamp signal and the right turn lamp signal are not received by said central control unit, to emit light with the fifth intensity when the brake lamp signal is received thereby, and to emit light with a seventh intensity higher than the fifth intensity when the right turn lamp signal is received thereby and regardless of whether the brake lamp signal is received by said central control unit.

4. The vehicle alerting device as claimed in claim 3, wherein said central control unit deactivates said first group of said light emitting components when all of the brake lamp signal, the right turn lamp signal and the headlamp signal are not received thereby, and deactivates said second group of said light emitting components when all of the brake lamp signal, the left turn lamp signal and the headlamp signal are not received thereby.

5. The vehicle alerting device as claimed in claim 3, wherein the fifth intensity is equal to the first intensity, the sixth intensity is equal to the second intensity, and the seventh intensity is equal to the third intensity.

6. The vehicle alerting device as claimed in claim 3, wherein the fifth intensity is different from the first intensity, the sixth intensity is different from the second intensity, and the seventh intensity is different from the third intensity.

7. The vehicle alerting device as claimed in claim 1, wherein said first group of said light emitting components is mounted on said base seat so as to form a left turn pattern when driven to emit light, and said second group of said light emitting components is mounted on said base seat so as to form a right turn pattern when driven to emit light.

8. The vehicle alerting device as claimed in claim 7, wherein said light emitting unit further includes a third group of said light emitting components, said central control unit driving said third group of said light emitting components to emit light when the brake lamp signal is received thereby.

9. The vehicle alerting device as claimed in claim 8, wherein said third group of said light emitting components is mounted on said base seat and is surrounded by said first group and said second group of said light emitting components.

10. The vehicle alerting device as claimed in claim 8, wherein said central control unit is configured to
drive said first group of said light emitting components to emit light with a first intensity when the brake lamp signal is received thereby, and to emit light with a second intensity higher than the first intensity when the left turn lamp signal is received thereby and regardless of whether the brake lamp signal is received by said central control unit,
drive said second group of said light emitting components to emit light with the first intensity when the brake lamp signal is received thereby, and to emit light with a third intensity higher than the first intensity when the right turn lamp signal is received thereby and regardless of whether the brake lamp signal is received by said central control unit, and
drive said third group of said light emitting components to emit light with the first intensity when the brake lamp signal is received thereby.

11. The vehicle alerting device as claimed in claim 8, the vehicle lamp control unit further providing a headlamp signal when a headlamp of the vehicle is turned on, wherein said central control unit further receives the headlamp signal, and is configured to, when the headlamp signal is not received thereby,
drive said first group of said light emitting components to emit light with a first intensity when the brake lamp signal is received thereby, and to emit light with a second intensity higher than the first intensity when the left turn lamp signal is received thereby and regardless of whether the brake lamp signal is received by said central control unit,
drive said second group of said light emitting components to emit light with the first intensity when the brake lamp signal is received thereby, and to emit light with a third intensity higher than the first intensity when the right turn lamp signal is received thereby and regardless of whether the brake lamp signal is received by said central control unit, and
drive said third group of said light emitting components to emit light with the first intensity when the brake lamp signal is received thereby; and
wherein said central control unit is further configured to, when the headlamp signal is received thereby,
drive said first group of said light emitting components to emit light with a fourth intensity lower than the first intensity when both of the brake lamp signal and the left turn lamp signal are not received by said central control unit, to emit light with a fifth intensity higher than the fourth intensity when the brake lamp signal is received thereby, and to emit light with a sixth intensity higher than the fifth intensity when the left turn lamp signal is received thereby and regardless of whether the brake lamp signal is received by said central control unit,
drive said second group of said light emitting components to emit light with the fourth intensity when both of the brake lamp signal and the right turn lamp signal are not received by said central control unit, to emit light with the fifth intensity when the brake lamp signal is received thereby, and to emit light with a seventh intensity higher than the fifth intensity when the right turn lamp signal is received thereby and regardless of whether the brake lamp signal is received by said central control unit, and
drive said third group of said light emitting components to emit light with the fourth intensity when the brake lamp signal is not received thereby, and to emit light with the fifth intensity when the brake lamp signal is received thereby.

12. The vehicle alerting device as claimed in claim 11 wherein said central control unit deactivates said first group of said light emitting components when all of the brake lamp signal, the right turn lamp signal and the headlamp signal are not received thereby, deactivates said second group of said light emitting components when all of the brake lamp signal, the left turn lamp signal and the headlamp signal are not received thereby, and deactivates said third group of said light emitting components when both of the brake lamp signal and the headlamp signal are not received thereby.

13. The vehicle alerting device as claimed in claim 1, further comprising a power supply unit coupled to said central control unit for supplying working power thereto.
